(19) United States
(12) Patent Application Publication
(10) Pub. No.: US 2022/0239173 A1
(43) Pub. Date: Jul. 28, 2022

(54) IMPROVEMENTS TO THE CONSTRUCTION OF AXIAL FLUX ROTARY GENERATORS

(71) Applicant: Time to Act Limited, Hertfordshire (GB)

(72) Inventor: Hugh-Peter Granville Kelly, Hertfordshire (GB)

(21) Appl. No.: 17/612,118

(22) PCT Filed: May 15, 2020
(86) PCT No.: PCT/GB2020/051192

§ 371 Date: Nov. 17, 2021

(30) Foreign Application Priority Data
May 17, 2019 (GB) 1906984.8

(51) Int. Cl. H02K 1/2793; H02K 3/04; H02K 21/24

(52) U.S. Cl. CPC H02K 1/2793; H02K 21/24; H02K 3/04

(57) ABSTRACT

An axial flux rotary generator comprising: two magnetic annuli; a coil annulus; the magnetic annuli and coil annulus having a common axis; the two magnetic annuli defining a plurality of magnetic fields around the common axis extending across a gap between the two magnetic annuli and the coil annulus having a sequence of coils around the common axis in the gap such that lines of magnetic flux cut the turns of the coils and thus induce electric current in the coils as the magnetic annuli are caused to rotate relative to the coil annulus; and at least one first part extending between the two magnetic annuli and at least one second part extending between the two magnetic annuli; wherein the first part is under greater compressive strain than the second part.

The invention disclosed herein relates to improvements in the construction of axial flux generators, and specifically to improvements in the construction of the rotor stacks thereof.

Axial flux generators are well known in which a series of in line annular rotors, each bearing on their facing surfaces permanent magnets, sandwich a series of annular stators embodying coils. The rotors are separated by intermediate collars to provide space for the sandwiched stators and are all mechanically interconnected by draw bolts passing therethrough.

The facing magnets borne by the rotors provide flux across the spaces between them, thereby cutting the turns of the coils embedded with the sandwiched stators. External means are used to rotate the rotors relative to the stators. As the lines of flux cut the coils, electricity is generated.

An important aspect of the construction and electromagnetic performance of such axial flux generators is the maintenance of an accurate and if possible small air gap between the surfaces of the magnets and the surfaces of the coils they are traversing. The smaller the air gap, the greater the electrical output. An ideal air gap is 6 mm or less. On substantially sized generators, having rotor and stator diameters of five meters or more, even up to ten meters, establishing and maintaining a precise air gap is mechanically difficult. Any variation in the thickness of the intermediate collar separating the rotors endangers the dimension of the said air gap. Should actual contact occur between the rotors and stators, it will be appreciated that the rotor magnets traversing past the stator coils would scrape against and quickly destroy them.

The present invention provides an axial flux rotary generator comprising: two magnetic annuli; a coil annulus; the magnetic annuli and coil annulus having a common axis; the two magnetic annuli defining a plurality of magnetic fields around the common axis extending across a gap between the two magnetic annuli and the coil annulus having a sequence of coils around the common axis in the gap such that lines of magnetic flux cut the turns of the coils and thus induce electric current in the coils as the magnetic annuli are caused to rotate relative to the coil annulus; at least one first part extending between the two magnetic annuli and at least one second part extending between the two magnetic annuli; and wherein the first part is under greater compressive strain than the second part. Thus in all situations the two magnetic annuli are in contact with both the first part and the second part.

This arrangement is advantageous as the first part can provide a substantial force against the surfaces of the rotors whilst the spacing between the rotors can be set precisely by the length of the second part.

The invention will now be described with reference to the following drawings in which:

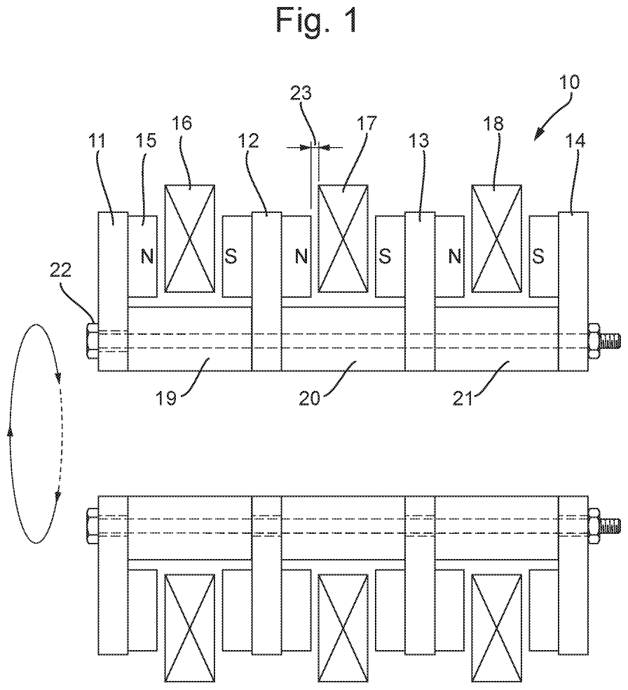

FIG. 1 depicts a typical stack of rotors spaced apart by collars

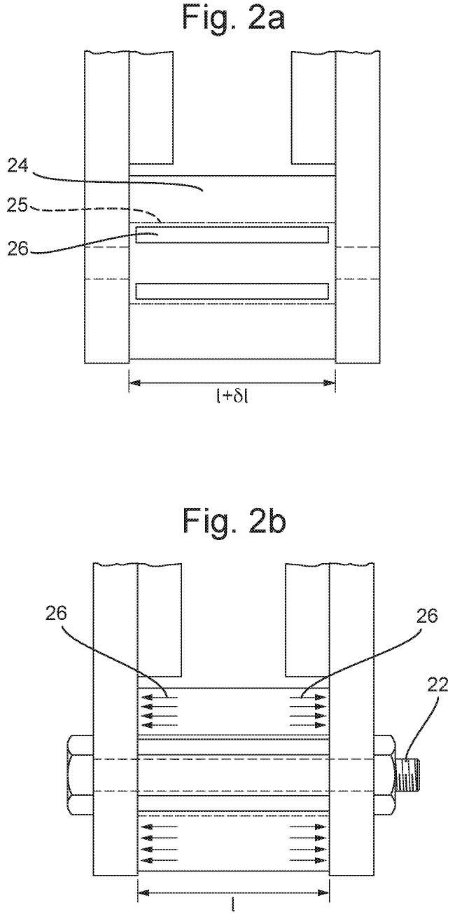

FIGS. 2a and 2b show the same arrangement, but modified to include the improvements of the present invention

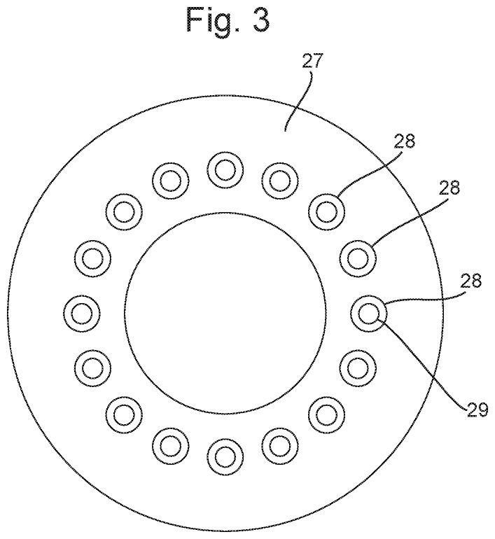

FIG. 3 shows in more detail, components of the arrangements of FIG. 2

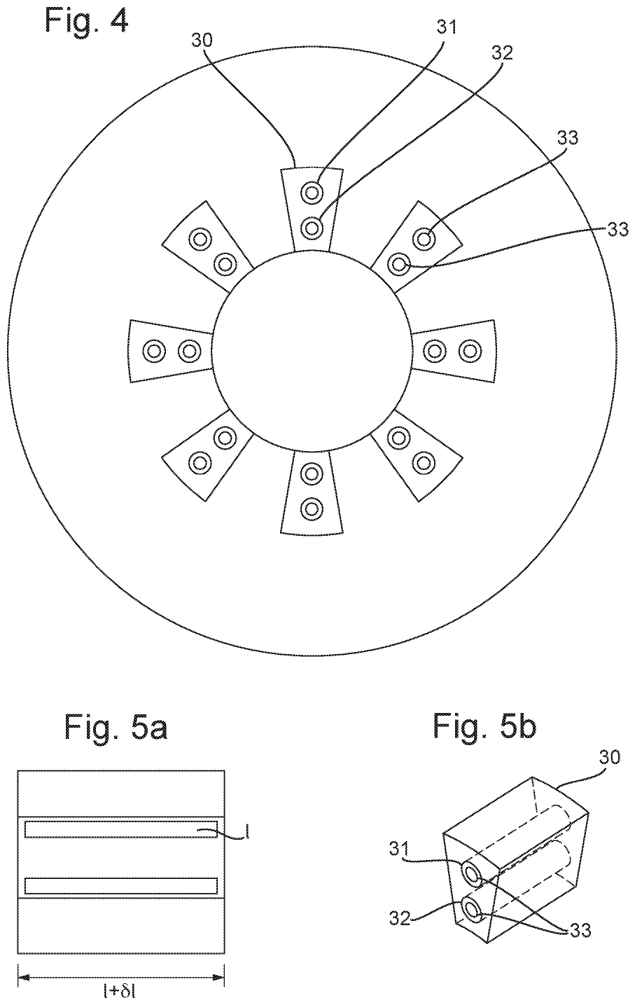

FIG. 4 shows a further variation to the arrangements of FIG. 2.

According to the invention, means for establishing precise spacing between rotors of axial flux generators comprises as a first part one or more collars constructed from substantially solid and rugged material providing the bulk of the surface adjacent to and pressing against the rotors but nevertheless very slightly compressible, and as a second part, a wholly solid and rugged material effectively non-compressible also located between the rotors, the axial length of which is shorter than that of the first part and which defines the exact spacing required between the rotors, and as a third part, draw bolts passing through the rotors and collars, the arrangement being such that upon the tightening of draw bolts, the rotors and collars are drawn in thus to form a solidly bound stack of rotors and collars, the final exact width between the rotors being defined by the axial lengths of the second part. The compressive strain in the first part is greater than that in the second part. The compressive strain is equal to the contraction divided by the original length.

The first part and second part are wholly in contact all the time with the two magnetic annuli and hold the two magnetic annuli to a constant predetermined separation.

The separation of the two magnetic annuli is constant through-out the whole range of rotational speeds of the axial flux rotary generator.

The first part is longer than the second part while under no stress, but is compressed by the force of the two magnetic annuli being drawn together by the draw bolts. The second part resists that force of the two magnetic annuli being drawn together and thus determines the spacing between the rotors. A compressive stress can be introduced into both the first part and the second part by further tightening of the draw bolts.

The second part is made of a material which is very stiff and does not compress greatly. For example the bulk modulus of the second part is preferably 40 GPa or more. Most metals have a bulk modulus of 40 GPa or more than this. Structural metals have a bulk modulus of 40 GPa or more, including aluminium and steels. Thus the second part may be made from a metallic material, preferably non magnetic in order not to disrupt/distort the magnetic fields provided by the rotor magnets. Preferably the bulk modulus of the second part is 60 GPa or more, for example aluminium.

In an embodiment the second part has a bulk modulus of 100 GPa or more. An example of a material which would be suitable for the second part with a bulk modulus of 100 GPa or more is steel. Stainless steel may be particularly suited to a task of the second part.

The first part is made of a material which has a lower bulk modulus than that of the first material. The first part can have a bulk modulus of 20 GPa or less. The bulk modulus may be 10 GPa or less. Plastics materials fall into this category. The bulk modulus of the first material must not be too low as otherwise the elasticity of the material provides little force against the surfaces of the rotors and therefore is less effective in maintaining spacing between adjacent rotors. Therefore, the first part preferably has a bulk modulus of 0.5 GPa or more, more preferably of 1.0 GPa or more.

A suitable material of the first part may be a plastics material such as nylon. This has the benefit of being relatively inexpensive compared to the material of the second part. Additionally, or alternatively the density of the material of the first part may be lower than that of the second part.

In an embodiment the first part is made of a different material to the second part.

The difference between the axial lengths of the first and second parts is predetermined such that upon tightening of the draw bolts, the first part is made to contract in terms of its axial length in such manner that the flanks thereof press powerfully against the sides of the rotors, thereby providing both their rigidity and axial orthogonality while the degree of their compression is precisely limited by the axial length of the second part. The exact required distance between the rotors, and thus the corresponding airgap between sandwiched stators, is thereby established.

A practical example would be a collar as the first part fabricated from a resilient but faintly compressible plastics material and having an uncompressed length of 350.5 mm. The axial length of the second part, which could for example be fabricated from stainless steel, would have an uncompressible length of 350 mm. Upon tightening of the draw bolts, the first part is thus compressed by 0.5/350.5=0.14% of its natural length. This can provide substantial force against the surfaces of the rotors on either side of it, even rising to several tonnes, while maintaining the aforesaid precise alignment and spacing between adjacent rotors.

According to a first aspect of the invention, the first part is in the form of a collar, having one or more axial recesses therethrough, and the second part is in the form of one or more members located within the said recesses.

This is the most convenient arrangement. However, the second part need not necessarily be formed in a recess or through hole in the first part.

According to a second aspect, the one or more members forming the second part are in the form of cylinders.

According to a third aspect, the draw bolts used to draw the rotors and their intermediate collars tightly together, pass through the aforesaid recesses in the first part and through the centres of the cylindrical second parts located within these recesses. The location of the second part cylinders thereby provides a rigid stop at the location of compression as provided by the draw bolts, thereby ensuring the most effective means of realising the object of the present invention.

Although the preferred embodiment employs draw bolts to draw the rotors together, other means may be used to draw the rotors together such as clamps.

A convenient way of arranging the draw bolts is to pass them through a through hole of the second part. However, this is not necessarily the case. The draw bolts, first part and/or second part may not be coaxial with one another. However, a coaxial arrangement in which the first part and second part and draw bolt are coaxial and the second part surrounds the draw bolt and the first part surrounds the second part is preferred as this arrangement makes assembly easiest.

A method of cooling generators as constructed herein is disclosed in my co-pending application no. GB 2,544,275. In this, gas is forced past the surfaces of the rotors and stators by introducing it under pressure into the central plenum chamber formed within the series of annular rotors and stators. The cooling gas egresses from the plenum chamber radially out past the aforesaid surfaces.

According to a fourth aspect of the invention, the collars spacing the rotors are also annular, and are dimensioned such that their inner diameters match or substantially match the inner diameters of the annular rotors, thereby facilitating the dispersion of the aforesaid gas under pressure.

Conveniently, the collar of the first part separating the rotors can be in the form of a single piece annulus for substantial machines. However this may not be desirable owing to the weight and cost of such a single piece.

According to a fifth aspect of the invention, the spacing means of the first part for providing separation between the rotors comprises a multiplicity of individual collars, each being furnished with the in effect incompressible cylinders of the second part operating as aforesaid.

The first part may be comprised of a plurality of first parts. The first parts may be distributed angularly evenly around the common axis of the magnetic annuli and coil annulus. This spreads the force generated between the first part and the magnetic annuli evenly so that the gap is a consistent size around the circumference of magnetic annuli. In an embodiment a gap is present between each of the plurality of first parts. This allows the passage of a cooling gas through the gap from the central plenum chamber. Each of the plurality of first parts can have one or more associated second parts.

An advantage arising from the arrangement of the invention is the substantial potential for reducing both weight and cost. Were the spacing collars for large generators to be constructed from traditional materials, such as aluminium or stainless steel, both their cost and weight would be prohibitive. However, the use of a plastics material saves substantially on each. Collars, either in whole or in sections, can be moulded to the required dimensions at a fraction of the cost of metal counterparts. The cylinders of the second part may be of modest dimensions compared to the first part, their only function being to limit the degree of compression of the first part, rather than necessarily providing any material buttressing support to the sides of the rotors.

Referring to FIG. 1, an annular rotor and sandwiched stator configuration of a typical axial flux generator is depicted at 10. Mechanical means (not shown) is used to rotate the rotors relative to the stators. For example the axial flux generator may be part of a wind generator and include a wind turbine for turning the generator.

Annular rotors 11, 12, 13 and 14 bear on their inner faces permanent magnets 15. Magnetic flux crosses the gap between facing north and south poles as shown. Annular stators 16, 17 and 18 embody stator coils which are cut by the traversing lines of flux, so generating electricity. Annular collars 19, 20 and 21 provide the required spacing between the rotors. Draw bolts, one of which is shown at 22, pass through recesses in the collars and rotors in order to bind and hold the whole assembly together.

It is desirable to minimise the air gap 23 between the permanent magnet 15 and coil 16, 18, 17 to the smallest extent possible commensurate with safe mechanical tolerances. In well-known fashion, the less the air gap, the greater the electrical output. However, and especially for very large machines, achieving a small air gap, and maintaining it, requires the fabrication of substantial and precisely ground collars, an expensive process. Necessarily made from metal, they also add substantially to the overall weight of the machine.

An alternative method of construction, and in accordance with the present invention, is now illustrated with reference to FIGS. 2a and b. These depict one section of an upper half of the generator as shown in FIG. 1. In this case, the collar 24 is made of a robust and durable material, for example an industrial plastic, but which is very slightly compressible while still maintaining its basic shape. Its natural length, as shown in FIG. 2a, is I+δI. Located within an axial recess 25 along the collar is a cylindrical sleeve 26 itself fabricated (in this case) from an in effect incompressible material, e.g. stainless steel. The length of the sleeve is set at I, being the precise spacing required between facing rotor annuli.

Referring to FIG. 2b, the draw bolt 22 is vigorously tightened so as to compress the collar 24, and thereby squeeze it precisely to the length of the sleeve 25. In so doing, the flanks of the faintly compressible collar are caused to press powerfully against the rotor sides, as shown by the arrows 26—so maintaining axial orthogonality of the rotors relative to the axis of the machine—as well as a precise predetermined spacing between them.

The use of a plastics material (for example nylon) greatly reduces both weight and expense. The choice of an inert material furthermore saves on the expense of surface treatment of a collar were it to be fabricated from metal.

In practice, and with reference to FIG. 3, a multiplicity of recesses may be provided, as shown upon the rotor 27 at 28. Each is furnished with an incompressible sleeve, 29, thereby ensuring a substantially equal distribution of compression forces across the inner surfaces of the rotor.

For extremely large generators (e.g. those having diameters of 5 meters of more), rather than employing single annular collars to space the rotors, these may instead be replaced by a number of single block spacers, as shown with reference to FIG. 4 and FIGS. 5a and 5b. The individual blocks are shown at 30, and two axial recesses 31 and 32 are provided within each for the location of the incompressible sleeves 33 and draw bolts (latter omitted for clarity) passing therethrough. A sufficient number of blocks is employed to ensure even distribution of compressive forces upon the magnet bearing faces of the rotors.

As shown most clearly in FIG. 4, the single block spacers have an inner surface which are aligned with, or match substantially, an inner radius of the magnetic annulus. This ensures that the central cavity of the axial flux generator has good cooling gas flow within it and thereby facilitating the dispersion of the aforesaid gas under pressure for radial distribution past the coil and magnetic annuli.

Numerous variations will be apparent to those skilled in the art.

1. An axial flux rotary generator comprising:
two magnetic annuli;
a coil annulus;
the magnetic annuli and coil annulus having a common axis;
the two magnetic annuli defining a plurality of magnetic fields around the common axis extending across a gap between the two magnetic annuli and the coil annulus having a sequence of coils around the common axis in the gap such that lines of magnetic flux cut the turns of the coils and thus induce electric current in the coils as the magnetic annuli are caused to rotate relative to the coil annulus;
at least one first part extending between the two magnetic annuli and at least one second part extending between the two magnetic annuli; and
wherein the first part is under greater compressive strain than the second part.

2. The axial flux generator of claim 1, wherein the first part has a bulk modulus which is lower than a bulk modulus of the second part.

3. The axial flux generator of claim 1, wherein each second part is in an axial recess of an associated first part.

4. The axial flux generator of claim 1, wherein the second part is cylindrical.

5. The axial flux generator of claim 1, further comprising a plurality of draw bolts drawing the two magnetic annuli towards one another and into contact with axial ends of the at least one second part.

6. The axial flux generator of claim 5, wherein the second part has an axial through hole.

7. The axial flux generator of claim 6, wherein the plurality of draw bolts are in the axial through hole of the second part.

8. The axial flux generator of claim 1, wherein each first part has at least one associated second part.

9. The axial flux generator of claim 1, comprising a plurality of first parts, the first parts distributed angularly evenly around the common axis.

10. The axial flux generator of claim 9, comprising a gap between each of the plurality of first parts for the passage of a cooling gas therethrough.

11. The axial flux generator of claim 1, wherein the material of the first part is a different material to the material of the second part.

12. The axial flux generator of claim 1, wherein the material of the first part is a plastics material.

13. The axial flux generator of claim 1, of the second part is a metallic material.

14. The axial flux generator of claim 1, wherein the material of the first part has a bulk modulus of 20 GPa or less, preferably of 10 GPa or less.

15. The axial flux generator of claim 1, wherein the material of the first part has a bulk modulus of 0.5 GPa or more, preferably of 1.0 GPa or more.

16. The axial flux generator of claim 1, wherein the material of the second part has a bulk modulus of 40 GPa or more, preferably 60 GPa or more and even more preferably of 100 GPa or more.

17. The axial flux generator of claim 1, wherein the first part and second part are wholly in contact all the time with the two magnetic annuli and hold the two magnetic annuli to a constant predetermined separation.

18. The axial flux generator of claim 1, wherein the axial flux generator is arranged such that the separation of the two magnetic annuli is constant through-out the whole range of rotational speeds of the axial flux rotary generator.

19. The axial flux generator of claim 1, wherein the first and/or second parts have a radially innermost surface and the radially innermost surface of the first and/or second parts substantially radially matches an inner diameter of the magnetic annuli.

20. An axial flux rotary generator comprising:
two magnetic annuli;
a coil annulus;
the magnetic annuli and coil annulus having a common axis;
the two magnetic annuli defining a plurality of magnetic fields around the common axis extending across a gap between the two magnetic annuli and the coil annulus having a sequence of coils around the common axis in the gap such that lines of magnetic flux cut the turns of the coils and thus induce electric current in the coils as the magnetic annuli are caused to rotate relative to the coil annulus;
means for establishing precise spacing between the magnetic annuli comprising as a first part one or more collars constructed from substantially solid and rugged material providing the bulk of the surface adjacent to and pressing against the magnetic annuli but nevertheless very slightly compressible, and as a second part, a wholly solid and rugged material effectively non-compressible also located between the magnetic annuli, the axial length of which is shorter than that of the first part and which defines the exact spacing required between the magnetic annuli, and as a third part, draw bolts passing through the magnetic annuli and collars, the arrangement being such that upon the tightening of draw bolts, the magnetic annuli and collars are drawn in thus to form a solidly bound stack of magnetic annuli and collars, the final exact width between the magnetic annuli being defined by the axial lengths of the second part.
